(19) United States
(12) Patent Application Publication
(10) Pub. No.: US 2005/0082698 A1
(43) Pub. Date: Apr. 21, 2005

(54) Method and apparatus for producing optical disk substrates

(76) Inventors: George Gutman, Birmingham, MI (US); Michael Hennessey, South Lyon, MI (US); Barry Clark, Ortonville, MI (US); David Strand, Bloomfield Twp, MI (US)

Correspondence Address: ENERGY CONVERSION DEVICES, INC., 2956 WATERVIEW DRIVE, ROCHESTER HILLS, MI, 48309, US

(21) Appl. No.: 10/600,041

(22) Filed: Jun. 20, 2003

Related U.S. Application Data
(63) Continuation-in-part of application No. 10/185,246, filed on Jun. 26, 2002.

(51) Int. Cl. B29D 11/00

(52) U.S. Cl. 264/1.33; 264/1.6; 264/319; 425/406; 425/810

(57) ABSTRACT

The present invention provides a method and apparatus for the continuous manufacturing of optical memory or optical memory substrates, and/or optical disks, which includes supplying a web of material to a substrate forming apparatus, embossing a microform image onto a polymeric film, such as an information track structure for an optical device, onto one or both sides of the web with a flat stamper and punching a hole through the web during the embossing. During the embossing, the polymeric material is heated to above the glass transition temperature (Tg). A flat stamper limits the potential for warp in the web, particularly when the web is stabilized in the stamp zone. The disclosed invention is particularly useful in the production of optical disk substrates, such as polycarbonate, having a thickness of 0.6 mm or less.

### RELATED APPLICATION DATA

The present application is filed under 35 USC § 1.53(b) as a Continuation-in-Part of U.S. patent application Ser. No. 10/185,246, filed on Jun. 26, 2002, which is hereby incorporated herein by reference.

### FIELD OF THE INVENTION

The present invention relates to methods and apparatus for making optical memory. More particularly, the present invention pertains to manufacturing optical disks having pits-and-lands or grooves-and-lands pattern. Further, the present invention relates to an apparatus and method for simultaneously embossing patterns with a platen stamper on thin polymeric films for use with optical disks and punching a centered hole through the disk.

### BACKGROUND OF THE INVENTION

Optical memory disks, such as CD (compact disks), CD-R, CD-RW; DVD (digital versatile disks), DVD-R, DVD-ROM, DVD-RAM, DVD+RW, DVD−RW, PD (phase change disks) and MO (magneto optical), etc., are typically manufactured by initially forming a substrate and then depositing one or more thin film layers upon the substrate. Substrates for optical memory are usually formed with a series of grooves and/or pits arranged as concentric tracks or as a continuous spiral. The grooves and pits may be used for things such as laser beam tracking, address information, timing, error correction, data, etc. Substrates used for optical disks are typically formed by injection molding, where a molten polymeric material is injected into a disk shaped mold with one surface having the patterned microstructure to be replicated. The patterned microstructure is typically provided by an exchangeable insert, commonly referred to as a stamper. The injection molding process is comprised of a series of precisely timed steps, which include closing the mold, injecting the molten polymer, providing a controlled reduction in peak injection pressure, cooling, center-hole formation, opening the mold and removing the replicated disk and associated sprue. Following the molding process, disk substrates are typically coated with one or more thin film layers. Thereafter, substrates may be coated with various insulating and/or protective layers, bonding adhesive, decorative artwork, labels, etc.

Besides lower than desired production rates, injection molding requires complex closed-loop control over numerous parameters. For example, mold and polymer temperature, press clamp force, injection profile and hold time all have competing and often-opposed influences on birefringence, flatness, and on the accuracy of the replicated features.

To speed-up the rate of manufacturing to realize embossing on thin films, a number of methods for manufacturing optical memory using continuous web processes have been proposed. These methods are built on the concept of forming a microstructure pattern on a continuous web of material by passing the web between a roller and a stamper.

To date, there have been two types of continuous web processes proposed. These processes include “in-line” and “off-line” methods. In-line continuous web processes integrate web extrusion with microstructure pattern formation in the same process, while off-line continuous web processes carry out web formation on pre-fabricated web material which is manufactured on another production line. The goal of in-line formation is to contact the web with a stamper immediately after web extrusion and while the web is still hot. Examples of in-line processes include those described in U.S. Pat. Nos. 5,137,661; 4,790,893; 5,433,897; 5,368,789; 5,281,371; 5,460,766; 5,147,592; and 5,075,060, the disclosures of which are herein incorporated by reference. The integration of web extrusion and web formation requires that a disk manufacturer not only engage in the business of producing optical disks but also in web extrusion. This makes the overall system a highly complex process, at a point in the process where it may not be desirable. Furthermore, because the disk manufacturer may not enjoy the same economies of scale that a plastic web manufacturer does, the cost per unit for disks formed with in-line processes may be higher than that for off-line processes. Thus, the present inventors propose that off-line processing not only offers the opportunity for improved throughput, reduced cost and complexity, and shorter start-up time, but for increased process flexibility as well.

One method of web formation, which may be used for in-line processes for optical memory production, is proposed by Kime, U.S. Pat. No. 6,007,888, entitled “Directed Energy Assisted In Vacuo Micro Embossing” which issued Dec. 28, 1999, the disclosure of which is herein incorporated by reference. Kime discloses a continuous manufacturing process using directed energy assisted micro embossing. The patent describes a directed energy source used to heat web material and a stamper before they are pressed together by a pair of nip rollers.

Although the '888 patent is well regarded for what it teaches, when increasingly higher density data devices are formed, a number of factors not normally at issue arise. For example, the present inventors have found that unavoidable variation in web surface texture and web thickness exist and can interfere with fine microstructure reproduction. These variations result in locally, non-uniform contact pressure between the web and stamper. In a process where the web is softened to form the microstructures, simply increasing the average contact pressure fails to adequately solve this problem, as excessively high contact pressure may result in a distorted image of the surface due to elastic rebound within the web material after pressure is removed. Stamper web relative movement can also cause ‘smearing’. Smearing distorts the shape of the data tracks and/or pits on a microscopic scale. These distortions can interfere with tracking and can also increase read-back error rates. Accordingly, there is a need for a method and/or apparatus, which accommodates the negative effects produced by variations in web surface texture and web thickness.

Described prior hereto in U.S. patent application Ser. No. 10/185,246, which is hereby incorporated herein by reference, an image is formed onto a web of substrate, then a hole is punched using a separate apparatus that centers the hole puncher using optical sensors. However, imperfections may occur that distort the image being replicated and/or produces a non-centered hole in the disk, either of which reduces the reliability of the disk. Additionally, roll-to-roll processes are difficult to employ with very thin films, i.e. films 0.1 mm or less, due to warping. Accordingly, there is a need for a continuous method for producing optical memory and/or apparatus having a pits-and-lands, grooves-and-lands pattern or both that is produced using a flat stamper hot embossing process that also simultaneously creates a centered hole during the embossing process.

### SUMMARY OF THE INVENTION

In response to the foregoing issues, the present invention provides a method and/or apparatus for the continuous manufacturing of optical memory or optical memory substrates, and/or optical disks, which includes supplying a web of material to a substrate forming apparatus, embossing a microform image, such as an information track structure for an optical device, onto the web with at least one flat stamper and creating a hole through the web during the embossing.

A preferred embodiment of the present invention is a method of forming microstructures on the surface of polymeric material comprising the steps of providing a web of polymeric material, adapting the web of polymeric material to continually flow into and out of a stamp zone between a first platen and a second platen, embossing at least one microstructure image on the polymeric material with the stamper and punching a hole through the web of polymeric material. At least one of the platens has a stamper equipped with a microstructure image for replication. The stamper preferably has a substantially flat surface with at least one microstructure image. The various embodiments disclose several methods for punching a hole through the substrate. The punching step may include positioning a punch nip on the stamper, setting a hole puncher in either of the platens and setting a hole punch receiver in the opposing platen. Preferably, the stamper is heated and the web is heated to above the glass transition temperature (Tg).

A preferred embodiment of the present invention further discloses a method that includes stabilizing the web of polymeric material in the stamp zone during the embossing. Stabilizing the web in the stamp reduces the possibility of imperfections in the microstructure image caused by the continuous flow of the web through the stamp zone during embossing. Stabilizing the web in the stamp reduces the pull on the web that can cause smearing and/or stretching of the microstructure image.

To stabilize the web in the stamp zone, the present method includes increasing slack in the web of polymeric material flowing toward the stamp zone as the stamper contacts the web of polymeric material and decreasing slack in the web of polymeric material flowing away from said stamp zone as the stamper contacts the web of polymeric material. The method also includes decreasing slack in the web of polymeric material as the web of polymeric material flows into the stamp zone and increasing slack in the web of polymeric material as the web of polymeric material flows out of the stamp zone. A preferred embodiment of the present invention discloses a first piston for decreasing and increasing slack upstream from said stamp zone and a second piston for increasing and decreasing slack downstream from said stamp zone.

The present invention discloses an apparatus for use in making optical memory. The apparatus includes a continuous web of polymeric material, a first platen and a second platen and means for punching a hole through the web. The web is adapted to flow between the platens to form a stamp zone. Additionally, at least one of the platens is equipped with a stamper having a substantially flat surface and at least one microform image to be embossed onto the web of polymeric material. The microform image is embossed onto the web in the stamp zone. The means for punching a hole may include a punch nip set in the microform image, a retractable hole puncher set in said flat stamper and a retractable hole puncher set in the alignment plate. The apparatus may further include a web cutter for sectioning the web after forming and a collector for accumulating sections of the web after cutting.

A preferred embodiment includes means for stabilizing the web in the stamp zone. The means for stabilizing may include means for increasing slack in the web of polymeric material upstream from the stamp zone as the stamper contacts the web of polymeric material, means for decreasing slack in the web of polymeric material downstream from the stamp zone as the stamper contacts the web of polymeric material, means for decreasing slack in the web of polymeric material as the web of polymeric material flows into the stamp zone and means increasing slack in the web of polymeric material as the web of polymeric material flows out of the stamp zone.

A more preferred embodiment includes a first piston as means for decreasing and increasing slack upstream from the stamp zone and a second piston as means for increasing and decreasing slack downstream from said stamp zone. The first piston increases slack in the web flowing toward the stamp zone as the stamper contacts the web and decreases slack in the web as the web flows into the stamp zone. The second piston decreases slack in the web flowing away from said stamp zone as the stamper contacts the web and increases slack in the web as the web flows out of the stamp zone.

One embodiment of the present invention provides a method and apparatus to punch a hole in a web of polymeric material during an embossing step, wherein the embossing step is performed with a flat stamper during a continuous process or apparatus.

Another embodiment of the present invention provides a process for hot embossing a thin film (thickness of 0.6 mm or less, preferably 0.25 mm or less) that simultaneously embosses information and track structure on one side of a polymeric material and accurately punches a centered hole that does not interfere with the reading of the disc.

Another embodiment of the present invention provides a method for embossing an information structure for an optical memory device, wherein the embossed area of a polymeric film is heated to above the glass transition temperature (Tg), and the center area of the embossed spiral inside the information structure remains sufficiently cool to punch a hole through the polymeric film simultaneous to the embossing.

Another embodiment of the present invention provides a process for hot embossing a thin film (thickness of 0.6 mm or less, preferably 0.25 mm or less) that simultaneously embosses information and track structure on both sides of a polymeric material and accurately punches a centered hole that does not interfere with the reading of the disc.

Another embodiment of the present invention provides a hot embossing process that stabilizes a web of polymeric material during the hot embossing process to result in a higher quality replication.

Another embodiment of the present invention provides a hot embossing process that limits and preferably eliminates movement of the polymeric material in the stamp zone during the hot embossing process.

Another embodiment of the present invention provides a hot embossing process and apparatus that embosses a high quality diffraction structure, which includes embossing in a vacuum.

Another embodiment of the present invention provides a flat stamper hot embossing process that includes punching a central hole of a disc simultaneously with the hot embossing, which eliminates the extra time and expense required to punch a hole in a separate step. Also, the simultaneous embossing and hole punching eliminates a possible source of imperfections in the disk.

Another embodiment of the present invention provides a method of embossing a thin web of polymer material (thickness of 0.6 mm or less, preferably 0.25 mm or less) with a recording structure on one or both sides utilizing a flat stamper, then bonding the polymer material to a substrate to produce a DVD-9 or DVD-18 optical disk.

### BRIEF DESCRIPTION OF THE DRAWINGS

In order to assist in the understanding of the various aspects of the present invention and various embodiments thereof, reference is now be made to the appended drawings, in which like reference numerals refer to like elements. The drawings are exemplary only, and should not be construed as limiting the invention.

FIG. 1 is a perspective view of an apparatus for forming web material for use in optical memory in accordance with the present invention, which illustrates an upper platen stamper equipped with a punch nip;

FIG. 2 is a perspective view of another apparatus for forming web material in accordance with the present invention, which illustrates an upper platen stamper equipped with a puncher;

FIG. 3 is a perspective view of another apparatus for forming web material in accordance with the present invention, which illustrates a lower platen stamper equipped with a puncher and an embodiment in which both platens are equipped with a stamper to simultaneously emboss both sides of the web;

FIG. 4A is a perspective view of another apparatus for forming web material in accordance with the present invention, which illustrates a pay off piston in a retracted position and a take up piston in an extended position;

FIG. 4B is a perspective view of another apparatus for forming web material in accordance with the present invention, which illustrates a pay off piston in a mid extended position and a take up piston in a mid extended position;

FIG. 4C is a perspective view of another apparatus for forming web material in accordance with the present invention, which illustrates a pay off piston in an extended position and a take up piston in a retracted position;

FIG. 5 is a perspective view of a web surface after embossing in accordance with the present invention that details the level bridges between the pits and grooves of an optical memory device embossed into a web; and

FIG. 6 is a perspective view of a platen stamper in accordance with the present invention.

### DETAILED DESCRIPTION OF THE INVENTION

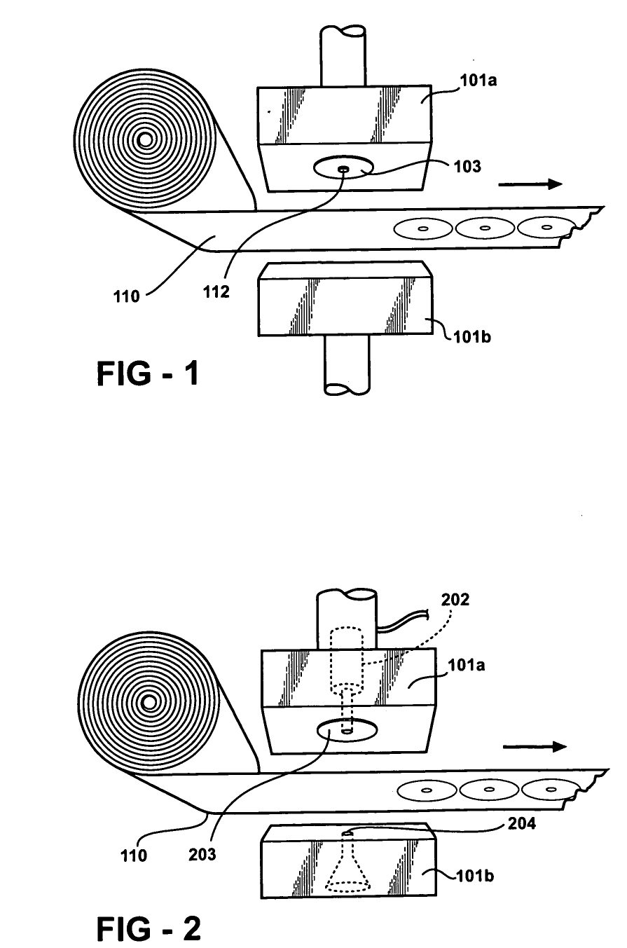

Referring now to FIG. 1, depicted therein is a device for forming optical memory in accordance with the present invention. The device includes a web payoff device, or simply a web payoff, a web path in which web material 110 travels, and a web forming apparatus disposed in the web path. The web forming apparatus includes at least one stamper 103. The stamper 103 carries at least one microform image for embossing the web 110. The stamper 103 may be supported by a platen 101a, which is supported by a carrier. The stamper may be heated by any suitable heating device. Alternative heating methods include, the use of directed energy and pressing the carrier between heated platens, electrical or oil heater, direct heating by passing electrical current through the stamper and electrical heating adjacent to the stamper. Depending on the needs of a given system, more than one stamper may be incorporated. Referring to FIGS. 1 through 3, the each stamper has a substantially flat, preferably completely flat, surface.

The stamper is any tool suitable for leaving an impression in web material or optical memory substrate. The stamper is preferably a disk shaped embossing tool, although in alternative embodiments the stamper could have any shape, such an oblate disk, oval, rectangle, triangle, irregular, etc. The stamper preferably has fine features for producing microstructures in optical memory substrates, such as grooves and/or pits. The fine features may range from greater than several microns to 0.01 microns or less in width, length and depth.

The stamper 103 may be designed with a punch nip 112, as illustrated in FIG. 1. As the web 110 material is pressed between the platens 101a and 101b in the stamp zone, the punch nip 112 creates a hole in the web material 110. Preferably, the hole is centered in a circular design. Illustrating another preferred embodiment in FIG. 2, a hole puncher 202 may be situated in the stamper 203 and centered in a circular image. A corresponding receiving hole 204 is set in the opposing platen 101b. The receiving hole 204 is adapted to receive the hole puncher after the hole puncher 202 plunges through the web material 110. The material punched from the web material 110 is discarded through an opening in the opposing platen 101b. As the web material 110 is pressed in the stamp zone, the hole puncher 202 is designed to create a smooth hole in the web material 110 by thrusting through the web material 110 and into the receiving hole 204. However, any type of image may be embossed and a hole puncher may be situated at any point inside the image. For circular optical memory device, the hole puncher is preferably centered inside the information structure and embossing spiral.

Preferably the time of punching a hole is less than the time of stamper contact with the web. The hole should be punched while the web is a secured position to assure a smooth, accurate hole in the web. In a preferred embodiment, the heated stamper does not contact the area of the web to be punched, i.e. the center area of a polymer film for use with an optical disk. Optimally, a free area around the periphery of the area to be punched is available to ensure the area to be punched remains sufficiently cool. Further, the contact time should be sufficient to allow the web to conform to the microform image. An example of a microform image is illustrated in FIG. 5. The web preferably travels at a rate of 1 to 30 inches per second. The contact time between the stamper and the web is preferably 100 milliseconds to 5 seconds.

The stamper is preferably formed of a rigid material that can be heated to a peak process temperature while maintaining the ability to both form a microstructure on the surface of the web and to easily transfer energy to the interface between the stamper and web of polymeric material upon contact. Representative stamper materials include, nickel, chrome, cobalt, copper, iron, zinc, etc., and various alloys of these metals. The stamper may be composed of a single monolithic material, or of multiple layers of the same material or of different materials. The stamper is preferably comprised of a 0.1 to 1.0 mm thick plate of material, and is more preferably is comprised of an approximately 0.3 mm+/−0.1 mm thick plate of material.

With reference to FIG. 6, the stamp zone preferably contains the mating platens (not shown). Either or both of the mating platens may be equipped with a means for punching a hole with force 604 and the stamper 603 backed by a dielectric layer 609 and a conductive metal layer 610. The respective platen may provide support for the stamper 603, dielectric layer 609 and conductive metal layer 610 and any other layer of a given system such as an insulator layer or a backing plate. The polymeric material 110 is stabilized between the opposing platens (not shown) and the means for punching creates a hole 604 in the polymeric material 110 during the time duration of the embossing. Preferably, the hole punching takes less time than the embossing. For example, the center hole punch is positioned to extend through the various elements of the particular platen to punch a hole through the polymeric material into a hole punch receiver in the opposing platen, during the embossing.

The stamper or stampers may be positioned in the apparatus in several ways. As shown in FIG. 1, the stamper 103 is preferably flat with the exception of the microform image for embossing the web 110. FIG. 3 illustrates an embodiment in which both platens 301a and 301b are equipped with a stamper 303a and 303b having a microform image for embossing the web. The both platens 301a and 301b may be equipped with a tool suitable for leaving an impression in web material or optical memory substrate, as illustrated in FIG. 3. FIG. 3 also illustrates an embodiment in which a hole puncher may be situated in the lower platen and centered in a circular image, such as the microform image for embossing a layer of information/track structure. As the web material is pressed in the stamp zone, the hole puncher is designed to create a smooth hole in the web material by thrusting through the web material and into the receiving hole. A corresponding receiving hole may be set in the opposing platen. The receiving hole is adapted to receive the hole puncher and punched web material. Any type of image may be embossed and the hole puncher may be situated at any point inside the image. For circular optical memory device, the hole puncher is preferably centered inside the information structure and embossing spiral. Preferably, rollers are disposed on both the pay off side and the take up side of the lower platen to reduce the resistance as the web material flows through the stamp zone. Additionally, FIG. 3 illustrates an embodiment that provides a mechanism in which both sides of the web are embossed simultaneously.

In a preferred embodiment hereof, stamper dimensional variation is limited by providing the stamper with a coefficient of thermal expansion (and contraction) substantially matched to the thermal response of the stamper/web interface. In certain circumstances, particularly when a very hot stamper is contacted to a cooler web or cooler press, the contact can cause the hot stamper to cool quickly and contract. The contraction may be so great that image distortion can occur. By adjusting the thermal expansion/contraction properties of the stamper, reduced stamper/web differential motion upon stamper contact can be provided to improve image formation. In accordance with a preferred embodiment hereof, the stamper has a thermal contraction less than that of pure nickel or that of conventional nickel stampers. Thermal expansion/contraction is preferably less than 1%, more preferably less than 0.1% and more preferably less than 0.01% over web contact. Reduced thermal expansion and/or contraction may be provided by any suitable means, such as by forming the stamper from a material having a low coefficient of thermal expansion, or by forming the stamper as a multi-layered structure, etc. Reduced thermal expansion may be provided by making the stamper from an alloy, a ceramic, or coating the stamper with a different material having a low coefficient of thermal expansion. For example, a stamper may be made by coating a conventional nickel stamper with another metal, a metal alloy or a ceramic having a lower coefficient of thermal expansion. By selecting materials with a low coefficient of thermal expansion, a stamper with substantially no measurable relative contraction during web contact can be provided.

In another embodiment hereof, stamper dimensional variation may be reduced by limiting heat loss from the stamper to components of the web forming apparatus or the web or both. Heat loss may be limited in a number of ways including: providing a bias heat to the alignment plate; insulating the stamper from press components; and reducing the stamper contact time with the web.

The web preferably travels at a rate of 1 to 30 inches per second. The stamper may be compressed against the web by any suitable press or pressing device. The press preferably delivers a pressure of 500 PLI (pounds per lineal inch) or less to the stamper/web contact zone. The nipping pressure is preferably in the range of 50 PLI to 300 PLI.

Although the apparatus disclosed herein may have wide application in forming web material of all kinds, the web material is preferably a polymeric material of suitable optical, mechanical and thermal properties for making optical memory disks. Preferably, the web material is a thermoplastic polymer, such as polycarbonate, poly methyl methacrylate, polyolefin, polyester, poly vinyl chloride, polysulfone, cellulosic substances, etc. The web material preferably has a refractive index suitable for use in optical memory disks (for example, 1.45 to 1.65). The web thickness is preferably about 0.05 mm to about 1.2 mm, depending upon the intended application. The invention of the current application is particularly useful for embossing a thin film, i.e. a web with a thickness of 0.6 mm or less. The web is preferably wide enough for replicating one, two, three, four, or more images across the web. The web material may contain one or more additives, such as antioxidants, UV absorbers, UV stabilizers, fluorescent or absorbing dyes, anti-static additives, release agents, fillers, plasticizers, softening agents, surface flow enhancers, etc. The web material is preferably a prefabricated roll formed “off-line”, which may be supplied to the substrate forming apparatus at ambient temperature or may be supplied to the system at ambient temperature. Supplying the web material in the form of a roll to the system at ambient temperature allows for greater process flexibility and efficiency.

Film thickness will be approximately equal to the gap formed between opposing surfaces of the platens when the carriers are pressed together. At this time the heating system may be activated. The heater may be any suitable heating device, such as a directed energy source, inductive heating source, conductive heating source, radiating heating source, etc., or any combination or equivalent. The stamper is, preferably, independently heated from the other elements of the system, including the nip, web and alignment plate. The stamper is preferably heated just before it is carried to the stamp zone.

Heating is preferably supplied by a heating coil that produces direct resistive heating of the stamper, as illustrated in FIG. 6. The heating coil is preferably made with a conductive material, such as copper, aluminum, silver, etc. The heating coil may be comprised of a series of contoured conductors which are coupled to a suitable source of energy. The heating coil is preferably water cooled or oil cooled. The heating coil is preferably placed adjacent to the stamper so as to generate resistive heating in the stamper when the induction heating coil is energized. The heating coil is preferably placed within 1 mm to 50 mm of the stamper. As the stamper is heated by the heating coil, the stamper can be raised to a temperature sufficient to raise the temperature of the web above the glass transition temperature (Tg) to allow the desired embossing step to be performed. The amount and uniformity of coupling to the stamper can be selected by adjusting the size and geometry of the induction coil; by appropriately selecting the materials of the stamper; and by changing the distance between the stamper and the induction heating coil. Another method of heating includes positioning a heating coil on the side of the platen opposite the stamper. In this embodiment, the platen is a heat conductive material that transfers heat to the stamper. Additionally, an insulator, such as high temperature rubber, may be set between the platen and the stamper to allow increase the cooling time.

Momentarily raising the stamper/web interface temperature to Tg or above, but below Tf, allows rapid, stress free formation of the web surface to the shape of the microstructures of the stamper. While the stamper/web interface should be hot enough to enable embossing of the microform image, it should not be so hot that the cross section of the web is melted. Limiting the process thermal penetration depth to a minimum, such as to the depth of the structures being formed, can minimize sub-surface displacement and subsurface annealing of the material to reduce distortion and warp.

The time/temperature profile may be provided in a number of ways, including balancing stamper peak temperature with stamper thermal properties, adjusting the initial temperature and thermal response of the web, adjusting the initial temperature and thermal response of the stamper/web interface, and/or altering the thermal characteristics of the stamper and alignment plate that form the stamp zone. Within the contact time, the temperature of the web surface is ramped from near ambient to at or above Tg, but below Tf, and is then cooled to stabilize the image before the stamper separates from the web. Alternatively, the web may be preheated to above ambient, or to even above Tg before contacting the stamper to the web. Preferably the web surface temperature is dropped to Tg or below before the stamper separates from the web.

The stamper is preferably separated from the web at an interface temperature below the melt-flow temperature of the web (e.g. at a temperature less than Tf). It should be generally noted that interface cooling rate may be affected by a number of conditions, including: thermal conduction into the web, the thermal characteristics of the web/stamper interface, thermal conductivity of the stamper, supplying one or more insulating layers, and by active interface temperature control.

Although not desiring to be bound by theory, polymer response to a displacing force involves a viscous component and an elastic component. At Tf the viscous component dominates, and at Tcold (a temperature below Tg) the elastic component dominates. Above Tg (the glass transition temperature) a transition occurs where the increase in free volume allows rotational or translational molecular motion to take place. This freedom allows molecules to move past one another, causing viscous behavior to become more dominant. Embossing polymeric material at Ts or Tsoft (a temperature below Tf but above Tg) requires substantial relaxation of strain before stamper separation. In comparison, the various embodiments of the present invention contemplate embossing the disk substrate at below Tf, and cooling the stamper/web laminate to between Tf and Tg, but not necessarily below Tg, before separation. The optimum temperature points reached in various embodiments of the present invention permit the microstructures in the web to stabilize sufficiently after separation so as to hold their shape, while at the same time avoiding microscopic and macroscopic distortion related to stamper shrinkage. By controlling the time/temperature profile of the stamper/web interface, microstructures on the stamper may be transferred to the web with reduced defects, such as micro-smearing, track shape distortion, and warp. An additional benefit derived from a short time/high temperature thermal profile is a limited thermal penetration depth into the web material. A limited thermal penetration can aid in reducing sub-surface annealing of the polymer, which has been found to be a contributor to total warp. A lowered thermal load can reduce the depth of thermal penetration. While it is possible to reduce average thermal exposure by modifying the shape of the time/temperature profile to achieve extremely high peak temperature at the surface followed by a rapid cooling, this approach may have a practical limit imposed by the instability of certain polymers to excessively high peak temperature.

In a preferred embodiment of a method for forming polymeric web material, the web is also heated on the side opposite that where microstructures are formed, e.g. on the ‘blank side’, as illustrated in FIGS. 1 and 2. Heating on the ‘blank-side’ of the web allows for counteracting residual warping forces from post anneal cooling. Heat may be provided to the blank side by any suitable heating device as described above. The blank side of the web may be heated prior to entering the process stamp zone, such as by radiant heat or conductive heat, or may be heated in the process stamp zone simultaneously with microstructure formation. The blank side may also be heated in the same way as the stamper is heated, such as by induction heating. This approach may be extended to effect the simultaneous embossing of both sides of the web, as illustrated in FIG. 3.

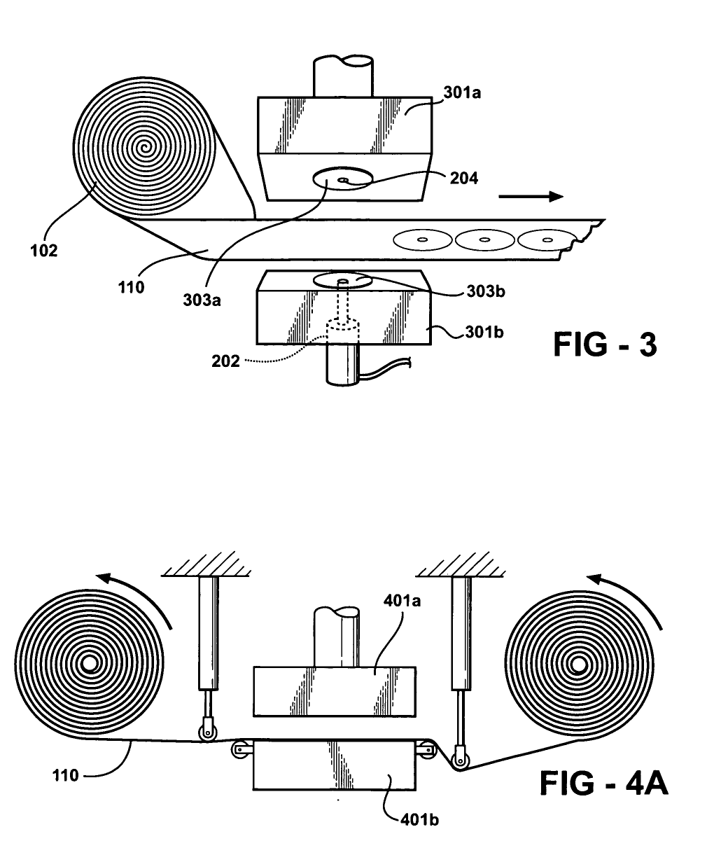

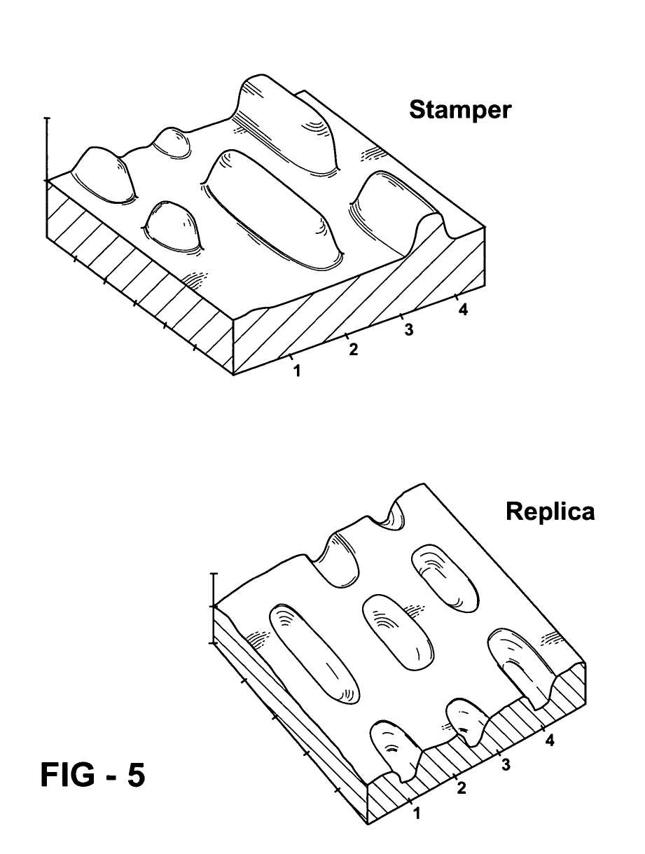

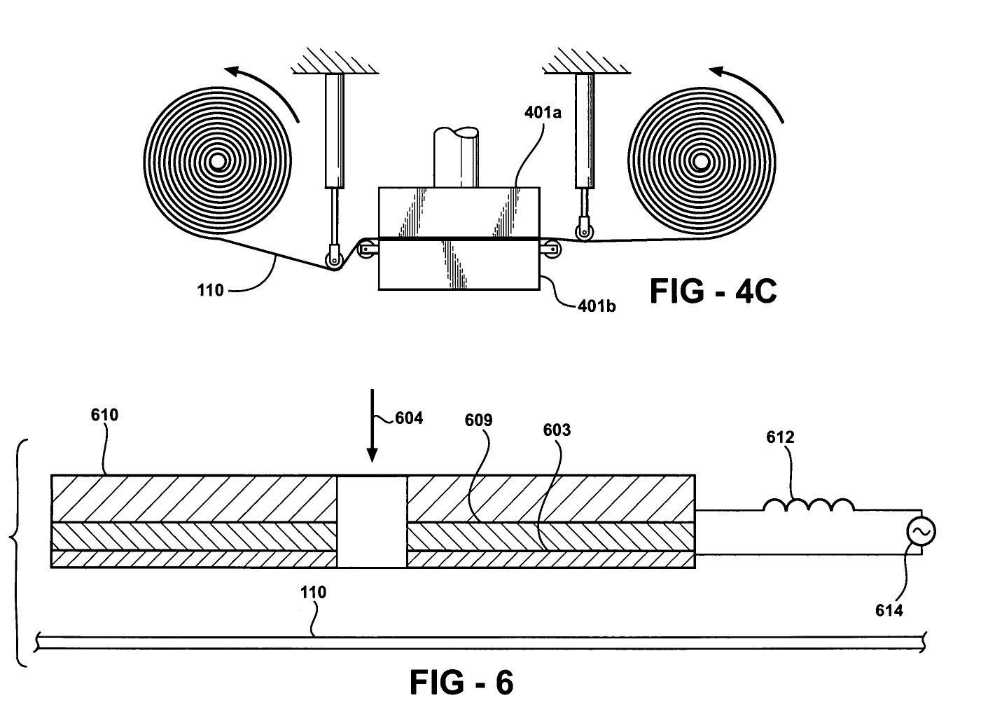

In practice, web material can be delivered to the stamp zone by any suitable web feed means. The means for feeding is preferably a device suitable for continuously delivering web material to the stamper along the web path, such as a sheet feed, folded material feed, roll feed, web extruder, etc. The web feed may be a feed as shown in FIGS. 4A through 4C for feeding pre-manufactured rolls of polymeric web material to the stamp zone and collecting the web material on a take up roll after the process is completed. The roll of polymeric web material preferably includes a removable film or protective layer of material, such as a softer plastic film layer on the web. By using web having a softer protective layer, the web may be rolled, unrolled, and re-rolled with minimal to no surface scratching, which could otherwise affect the use of the web for optical memory devices.

The web formation apparatus is preferably adapted to accommodate variations in web tension so that the web is neither over-taunt nor over-slacked. An over-taught web could result in the web breaking while an over-slacked web could cause jamming or other problems. Furthermore, tension control across the stamp zone should be controlled to reduce sub-surface material displacement. To accommodate variations in web tension, the system may be provided with one or more tension rollers. Tension rollers are generally known in material handling operations and may be used to control web speed and tension.

Tension may be controlled across the stamp zone, at the stamp zone in-feed, at the stamp zone out-feed, and otherwise across the system. Tension at the stamp zone in-feed is preferably near 0 to neutral.

In operation, the platens engage one another. As a result, the web is pressed between the stamper and the opposing platen or stamper, depending on the embodiment. The respective surfaces of the stampers are preferably selected to provide the necessary contact uniformity, to optimize stamp zone dynamic shape and to balance pressure distribution to minimize overall image distortion. Preferred construction materials include, but are not limited to, nitrile, EPDM, Kapton, epoxides, filled epoxides, Teflon, and Teflon infused polymer, metal or ceramic matrixes. It is also appreciated that any material with heat transfer properties suitable for melt forming an optical memory microstructure with less than ±0.8 degrees of radial deviation, and less than ±0.3 degrees of tangential deviation may be used.

While the invention has been illustrated in detail in the drawings and the foregoing description, the same is to be considered as illustrative and not restrictive in character as the present invention and the concepts herein may be applied to any formable material. It will be apparent to those skilled in the art that variations and modifications of the present invention can be made without departing from the scope or spirit of the invention. For example, the dimensions of the optical substrates, the manner of stabilizing the web in the stamp zone, the means for punching a hole in the web and the microstructures formed therein can be varied without departing from the scope and spirit of the invention. The materials used to construct the various elements used in the embodiments of the invention, such as the flat stamper, the stamper support, and the heater, may be varied without departing from the intended scope of the invention. Furthermore, it is appreciated that the support for the platen stamper and the alignment plate could be integrated so as to provide one structure. Still further, it is appreciated that the present invention extends to embodiments that use optical memory substrates in any form, be that web, sheet, or otherwise. Further, by using one or more of the embodiments described above in combination or separately, it is possible to simultaneously emboss a polymeric material with an information track structure and create a center hole using a flat stamper. Thus, it is intended that the present invention cover all such modifications and variations of the invention, that come within the scope of the appended claims and their equivalents.

1. A method of forming microstructures on the surface of polymeric material having a glass transition temperature (Tg) comprising the steps of
providing a web of polymeric material;
adapting the web of polymeric material to flow into and out of a stamp zone between a first platen and a second platen, wherein at least one of said first platen and said second platen having a stamper, each of said stampers having a flat surface with at least one microstructure image;
heating said stamper to at least the glass transition temperature (Tg);
embossing said microstructure image on the polymeric material with said stamper; and
punching a hole through the web of polymeric material in the stamp zone during said embossing.

2. The method of claim 1, wherein said punching includes positioning a punch nip on one of said first platen or said second platen.

3. The method of claim 1, wherein said punching includes setting a hole puncher in said first platen and setting a hole punch receiver in said second platen, said hole puncher thrusting through said web and into said hole punch receiver.

4. The method of claim 1, wherein said punching includes setting a hole puncher in said second platen and setting a hole punch receiver in said first platen, said hole puncher thrusting through said web and into said hole punch receiver.

5. The method of claim 3 or 4, wherein said hole punch receiver includes a web hole disposal zone.

6. The method of claim 1, wherein said heating said stamper comprises passing an electrical current through said stamper.

7. The method of claim 1, wherein said polymeric material has a thickness of about 0.6 mm or less.

8. The method of claim 7, wherein said polymeric material comprises an optical memory substrate material, said optical memory substrate material having an information structure.

9. The method of claim 7, wherein said embossing has a time duration of 5 seconds or less.

10. The method of claim 1, wherein the temperature of the heated stamper is above the glass transition temperature (Tg) of the polymeric material when contacting the web.

11. The method of claim 10, further comprising the step of separating the stamper from the web when the surface of the web is at a temperature below the glass transition temperature (Tg).

12. The method of claim 9, wherein punching time is less than embossing time.

13. The method of claim 1, said web traveling at a rate of between 1 inch per second and 30 inches per second into and out of said stamp zone.

14. The method of claim 1, the first platen having a first stamper and the second platen having second stamper, each of said stampers having a flat surface with at least one microstructure image.

15. The method of claim 1, wherein said heating said stamper comprises positioning a heater adjacent to said stamper.

16. The method of claim 1, wherein said heating said stamper comprises applying an induction field to said stamper.

17. The method of claim 1, further comprising the step of stabilizing the web of polymeric material in the stamp zone during said embossing.

18. The method of claim 17, wherein said means for stabilizing comprises intermittently stopping said web of polymeric material in said stamp zone during said embossing of the microform image.

19. An apparatus for use in making an optical memory device comprising:
a continuous web of polymeric material;
a first platen, said first platen in communication with said web of polymeric material;
a second platen, said web of polymeric material adapted to flow between said first platen and said second platen to form a stamp zone, said continuous web of polymeric material adapted to flow between said first platen and said second platen, at least one of said first platen and said second platen having at least one microform image comprising a negative of optically detectable marks to be created on said optical memory device, wherein each of the microform images is embossed onto said web of polymeric material in the stamp zone; and
means for punching a hole through said web in the stamp zone.

20. The apparatus of claim 19, further comprising means for stabilizing said continuous web in the stamp zone during said embossing of the microform image.

23. The apparatus of claim 20, wherein said means for stabilizing comprises intermittently stopping said web of polymeric material in said stamp zone during said embossing of the microform image.

24. The apparatus of claim 19, said means for punching a hole comprising a punch nip set in the first platen.

25. The apparatus of claim 19, said means for punching a hole comprising a retractable hole puncher set in said first platen and a hole punch receiver set in said second platen, said hole puncher adapted to thrust through said web and into said hole punch receiver.

26. The apparatus of claim 19, said means for punching a hole comprising a retractable hole puncher set in said second platen and a hole punch receiver set in said first platen, said hole puncher adapted to thrust through said web and into said hole punch receiver.

27. The apparatus of claim 19, said first platen adapted to emboss the microform image onto the polymeric material in the stamp zone.

28. The method of claim 19, said second platen adapted to emboss the microform image onto the polymeric material in the stamp zone.

29. The method of claim 19, said first platen having a first microform image and said second platen having second microform image, wherein the first microform image and the second microform image are simultaneously embossed onto said web of polymeric material in the stamp zone.

30. The apparatus of claim 19, wherein the web of polymeric material is heated to a temperature above the glass transition temperature (Tg) of the polymeric material.

31. The apparatus of claim 19, wherein the temperature of the first platen is below the glass transition temperature (Tg) of the polymeric material when contacting the web.

32. The apparatus of claim 31, wherein the stamper is separated from the web when the surface of the web is at a temperature above the glass transition temperature (Tg) of the polymeric material.
